(19) United States
(12) Patent Application Publication
(10) Pub. No.: US 2007/0070535 A1
(43) Pub. Date: Mar. 29, 2007

(54) Storage system and component replacement processing method thereof

(75) Inventor: Hirokazu Fujitani, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/365,822

(22) Filed: Mar. 2, 2006

(30) Foreign Application Priority Data
Sep. 27, 2005 (JP) 2005-280689

(51) Int. Cl. G11B 5/09

(52) U.S. Cl. 360/46

(57) ABSTRACT

A storage system is constructed by a hierarchy of a primary storage device and a secondary storage device. A storage system has a hierarchy of a primary storage device, secondary storage devices and a storage processor, an emulator device for emulating an identifier of a maintenance target unit. The emulator device is installed between the installation port of the maintenance target unit and the maintenance target unit, so that the storage system cannot recognize changes even if the maintenance target unit is replaced. By this, a complicated setup operation required to replace the maintenance target unit becomes unnecessary, and operation errors can be prevented.

### CROSS-REFERENCE TO RELATED APPLICATIONS

This application is based upon and claims the benefit of priority from the prior Japanese Patent Application No. 2005-280689, filed on Sep. 27, 2005, the entire contents of which are incorporated herein by reference.

### BACKGROUND OF THE INVENTION

1. Field of the Invention

The present invention relates to a storage system having a primary storage device and a secondary storage device, and the component replacement processing method thereof, and more particularly to a storage system for replacing the component of the secondary storage device without stopping operation of the primary storage device, and the component replacement processing method thereof.

2. Description of the Related Art

Because of the recent trend of computerizing data, larger capacities and secure data storage are demanded for storage systems for storing and holding data. For this demand, a virtual disk library device has been provided. A virtual disk library device is comprised of a combination of a disk storage device, where many magnetic disk drives are housed as a primary storage device, and a tape storage device, where a magnetic tape which is superb in archiving is used for a secondary storage device.

This virtual disk library device will be described with reference to FIG. 12. As FIG. 12 shows, the virtual disk library device has a disk storage device 200 which is connected to a host computer 100, fiber switches 300 and 302 which constitute a storage area network, tape storage devices 500 and 550, and a storage server 400, which positions between the disk storage device 200 and the tape storage devices 500 and 550, for providing a function of a virtual disk to the tape storage devices 500 and 550.

This disk storage device 200 has a host channel adapter 202, which is an interface with the host 100, a control unit (control manager) 204, a pair of storage control units 200 and 202 having a server channel 206, and many magnetic disk drives 220.

The tape storage devices 500/550, on the other hand, has many magnetic tapes 520/570, tape drives 510/560 for driving these magnetic tapes 520/570 and reading/writing data of the magnetic tapes, and robots 530/580 for moving a desired magnetic tape 520/570 to the tape drive 510/560 (e.g. Japanese Patent Application Laid-Open No. 2003-150322).

Since general purpose units are used for the disk storage device 200 and the tape storage devices 500/550, a storage server 400, for providing a function of the virtual disk to the tape storage devices 500/550, is installed between the disk storage device 200 and the tape storage devices 500/550.

The storage server 400 is comprised of a pair of server units 420/440. Each server unit 420/440 has a first host bus adapter 422, for connecting the disk storage device 200 via the fiber switches 300/320, and a second host bus adapter 424, for connecting the tape storage devices 500/550 via the fiber switches 300/320. The disk storage device 200, fiber switch 300/320, storage server 400 and tape storage device 500/550 are connected via a LAN (Local Area Network), and an external device can be connected to the port 600 thereof.

Even if this storage system is comprised of general purpose units 200, 300, 320, 400, 500 and 550 and the disk storage device 200 can handle read/write access from the host 100 at high-speed, the tape storage devices 500/550 can store large capacities of data at low cost, therefore a large capacity and high-speed virtual storage system can be constructed at low cost. So there are no components dedicated to the virtual disk library device, and components for a conventional device are used for replacement when maintenance is performed.

Conventionally to replace these components, a maintenance terminal (e.g. personal computer) 700 is connected to the LAN port 600, various settings are performed, then a component (e.g. tape drive, robot) is replaced. For example, before and after a component is replaced, control software for the secondary storage devices 500/550, hardware of the secondary storage devices 500/550, drivers of the storage processor (PW) 400 and the primary storage device 200, drivers of the storage processor (PW) 400 and the secondary storage devices 500/550, and the control software of the storage processor 400, are set from the maintenance terminal 700.

When such maintenance target components are replaced, there are many settings which are performed from the maintenance terminal 700, as mentioned above, where operation errors tend to occur by an operator of the maintenance terminal. Setting errors make the replacement operation longer, increase the time until the user can begin using the system, and causes problems to the user.

Also the storage processor (PW) inside the storage system must be restarted, and an operation error here may lead to machine down time.

### SUMMARY OF THE INVENTION

With the foregoing in view, it is an object of the present invention to provide a storage system for decreasing the setup operation for replacing maintenance target components, and the component replacement processing method thereof.

It is another object of the present invention to provide a storage system for decreasing the setup operation for replacing maintenance target components even if the storage system is constructed by general purpose units, and the component replacement processing method thereof.

It is still another object of the present invention to provide a storage system for preventing invalid access from the outside while decreasing the setup operation for replacing maintenance target components, and the component replacement processing method thereof.

To achieve these objects, the storage system of the present invention has: a primary storage device having a data storage section, for receiving an access request from a host, reading/writing data in the storage section, and returning the data to the host; a secondary storage device having a data storage section, for reading/writing data in the data storage section according to a read/write request from the primary storage device; a storage processor installed between the primary storage device and the secondary storage device, for having the secondary storage device virtually execute the read/write operation of the primary storage device when a request from the primary storage device is received; and an emulator device connecting at least one of the maintenance target units of the secondary storage device and the storage processor, for converting an identifier before replacement and an identifier after replacement of the maintenance target unit. And the emulator device converts the identifier of the maintenance target unit when exchanging information between the primary storage device and the secondary storage device.

The component replacement processing method of the present invention is a component replacement processing method for a storage system which has a primary storage device having a data storage section, for receiving an access request from a host, reading/writing data to the storage section, and returning the data to the host, a secondary storage device having a data storage section, for reading/writing data in the data storage section according to a read/write request from the primary storage device, and a storage processor installed between the primary storage device and the secondary storage device, for having the secondary storage device virtually execute read/write operation of the primary storage device when a request from the primary storage device is received. The method has steps of: connecting an emulator device to at least one of the maintenance target units of the secondary storage device and the storage processor and acquiring an identifier of the maintenance target component; and converting an identifier of the maintenance target unit by the evaluator device when exchanging information between the primary storage device and the secondary storage device after replacing the maintenance target component.

In the present invention, it is preferable that the emulator device detects the connection of one of the maintenance target units of the secondary storage device and the storage processor, acquires and stores an identifier of the maintenance target unit, detects the replacement of the maintenance target unit, acquires an identifier of the maintenance target unit after the replacement, and stores the identifier after the replacement corresponding to the identifier before the replacement.

Also in the present invention, it is preferable that the emulator device has a first port for connection to the primary storage device or the storage processor, a second port for connection to the maintenance target unit, a table for storing an identifier after the replacement corresponding to the identifier before the replacement, and a processing unit for referring to the table and converting an identifier of the maintenance target unit when exchanging information between the primary storage device and the secondary storage device.

Also in the present invention, it is preferable that when the emulator device detects that one of the maintenance target units of the secondary storage device and the storage processor is removed, the emulator device disables acceptance of a signal from the primary storage device or the storage processor which accesses the maintenance target unit from the first port, and when the emulator device detects that the maintenance target unit is replaced, the emulator device enables acceptance of the signal from the primary storage device or the storage processor.

Also in the present invention, it is preferable that when the emulator device detects that one of the maintenance target units of the secondary storage device and the storage processor is connected, the emulator device acquires and stores WWN of the maintenance target unit, and when the emulator device detects that the maintenance target unit is replaced, the emulator device acquires WWN of the maintenance target unit after the replacement, and stores WWN after the replacement corresponding to the WWN before the replacement.

Also it is preferable that the present invention further has an operation terminal connected to the primary storage device, secondary storage device and storage processor for disabling access to the maintenance target unit before replacing the maintenance target unit, and enabling access to the maintenance target unit after replacing the maintenance target unit.

Also in the present invention, it is preferable that the secondary storage device has a tape drive for driving a storage tape and a robot for transporting the storage tape between the tape drive and a tape storage section, and the emulator device is installed in one of the tape drive and the robot, which exchanges information with the storage processor.

Also in the present invention, it is preferable that the storage processor has an interface circuit for interfacing with the primary storage device, and the emulator device is installed in the interface circuit, which exchanges information with the primary storage device.

Also in the present invention, it is preferable that the primary storage device is a disk storage device, and the storage processor controls the secondary storage device as a virtual disk.

Also in the present invention, it is preferable that the secondary storage device has a tape drive for driving a storage tape, and a robot for transporting the storage tape between the tape drive and a tape storage section.

Since the emulator device for emulating an identifier of the maintenance target unit is installed between the installation port of the maintenance target unit of the storage system in hierarchical configuration and the maintenance target unit, the storage system cannot recognize changes even if the maintenance target unit is replaced. By this, a complicated setup operation required to replace the maintenance target unit becomes unnecessary, and operation errors can be prevented. Also since the emulator device is installed in the maintenance target unit, a security mechanism, which cannot be accessed from the outside, can be constructed.

### BRIEF DESCRIPTION OF THE DRAWINGS

FIG. 1 is a block diagram depicting the storage system according to an embodiment of the present invention;

FIG. 2 is a block diagram depicting the emulator device in FIG. 1;

FIG. 3 is a flow chart depicting the initialization processing of the emulator device in FIG. 2;

FIG. 4 is a diagram depicting the initialization operation in FIG. 3;

FIG. 5 is a diagram depicting the information transfer operation before replacement by the emulator device in FIG. 2;

FIG. 6 is a flow chart depicting the processing when the maintenance target unit is replaced by the emulator device in FIG. 2;

FIG. 7 is a diagram depicting the replacement processing operation in FIG. 6;

FIG. 8 is a flow chart depicting processing after replacement by the emulator device in FIG. 2;

FIG. 9 is a diagram depicting operation after replacement in FIG. 8;

FIG. 10 is a block diagram depicting the storage system according to the second embodiment of the present invention;

FIG. 11 is a block diagram depicting the storage system according to the third embodiment of the present invention; and

FIG. 12 is a diagram depicting the component replacement operation of a conventional storage system.

### DESCRIPTION OF THE PREFERRED EMBODIMENTS

The present invention will now be described in the sequence of first embodiment of the storage system, emulator device, second embodiment of the storage system, third embodiment of the storage system, and other embodiments, but the present invention is not limited to these embodiments, but can be modified in various ways, and shall not exclude these variant forms.

### First Embodiment of the Storage System

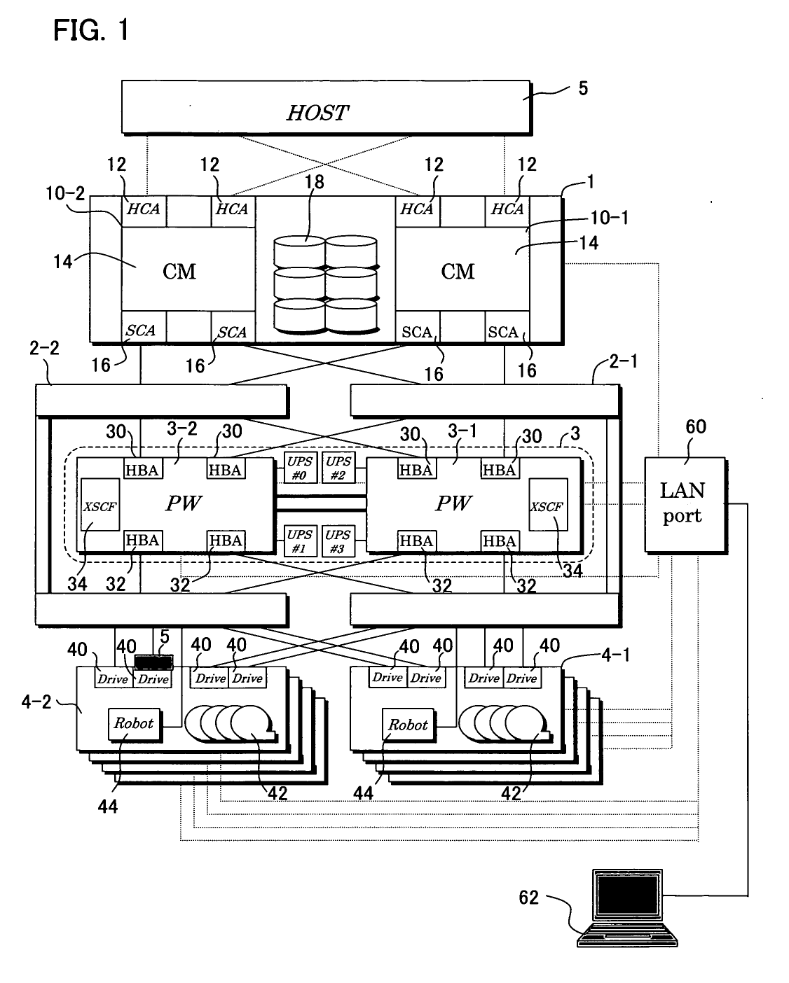

FIG. 1 is a block diagram depicting the first embodiment of the storage system of the present invention, and shows the virtual disk library device as an example.

As FIG. 1 shows, the storage system has a disk storage device 1 which is connected to the host computer 6, fiber switches 2-1 and 2-2 for constructing the storage area network, tape storage devices 4-1 and 4-2, and a storage server (processor) 3 which is located between the disk storage device 1 and the tape storage devices 4-1 and 4-2 for providing the function of the virtual disk to the tape storage devices 4-1 and 4-2.

This disk storage device 1 has a pair of storage control units 10-1 and 10-2, and many magnetic disk drives 18 which are accessed by these storage control units 10-1 and 10-2.

The storage control units 10-1 and 10-2 have identical configurations. In other words, each storage control unit 10-1/10-2 has a pair of host channel adapters 12 which interface with the host 6, a control section (control manager) 14, and a pair of server channel adapters 16 which interface with the storage server 3.

This pair of storage control units 10-1 and 10-2 forms a redundant configuration, and each storage control unit 10-1/10-2 has a plurality of hosts/server adapters 12 and 14, so both input and output are in a redundant configuration.

The tape storage devices 4-1 and 4-2 also have identical configurations. Each tape storage device 4-1/4-2 has many magnetic tapes 42 housed in a storage rack (not illustrated), a plurality of (four in this case) tape drives 40 for driving this magnetic tape 42 and reading/writing data of the magnetic tape 42, and a robot 44 for transporting a desired magnetic tape 42 on the storage rack to the tape drive 40, and returning the magnetic tape 42 from the tape drive 40 to the storage rack.

Since general purpose units are used for the disk storage device 1 and the tape storage devices 4-1 and 4-2, the storage server 3, for providing the virtual disk access function to the tape storage devices 4-1 and 4-2, is installed between the disk storage device 1 and the tape storage devices 4-1 and 4-2.

The storage server 3 is comprised of a pair of storage processors 3-1 and 3-2, one for current use and the other is for standby. Each storage processor 3-1/3-2 has a pair of host bus adapters 30 for connecting the server channel adapter 16 of the disk storage device 1 via the fiber switch 2-1/2-2, and a pair of host bus adapters 32 for connecting the tape storage device 4-1/4-2 via the fiber switch 2-1/2-2. Each storage processor 3-1/3-2 has a port 34 for the maintenance terminal.

The fiber switch 2-1 connects one server channel adapter 16 of each control unit 14 of the disk storage device 1 and the host bus adapter 30 of each storage processor 3-1/3-2. The fiber switch 2-1 connects one host bus adapter 32 of each storage processor 3-1/3-2, and the tape drive 40 and the robot 44 of the tape storage device 4-1/4-2.

In the same way, the fiber switch 2-2 connects the other server channel adapter 16 of each control unit 14 of the disk storage device 1 and the host bus adapter 30 of each storage processor 3-1/3-2. The fiber switch 2-2 connects the other host bus adapter 32 of each storage processor 3-1 and 3-2, and the tape drive 40 and the robot 44 of the tape storage device 4-1/4-2.

In other words, by the fiber switches 2-1 and 2-2, both the control units 10-1 and 10-2 of the disk storage device 1 can be connected to the current storage server 3-1 and the storage server for standby 3-2, and both the current storage server 3-1 and the storage server for standby 3-2 can be connected to the plurality of tape drives 40 and of the tape storage devices 4-1 and 4-2.

The disk storage device 1, fiber switches 2-1 and 2-2, storage server 3 and tape storage devices 4-1 and 4-2 are connected via a LAN (Local Area Network), and peripheral equipment can be connected to the port 60 thereof.

Here if the maintenance replacement target component is the tape drive 40 of the tape storage device 4-2, the emulator device 5 is installed between the tape drive 40 and the fiber switch 2-2. For maintenance replacement, the maintenance terminal (e.g. personal computer) 62 is connected to the LAN port 60.

First a conventional maintenance replacement operation, where the above emulator device 5 is not installed, will be described for comparison.

(1) The status of each unit is acquired from the LAN port 60 by the browser of the maintenance terminal (hereafter called operation terminal) 62, and abnormalities of the tape drive 40 of the tape storage device 4-2 are confirmed.

(2) The operator visually confirms the abnormalities of the tape drive 40 on the operator panel (not illustrated) of the tape storage device 4-2.

(3) By this confirmation, a command is issued from the operation terminal 62 to the storage server 3, and access from the storage server 3 to the tape drive 40 is disabled.

(4) WWN (World Wide Name, old WWN) of the maintenance target tape drive 40 is acquired on the operation terminal 62 via the LAN port 60.

(5) The operator operates the operator panel of the tape storage device 4-2, and changes the tape drive 40 to offline mode.

(6) After disconnecting the maintenance target tape drive 40 in this way, the maintenance target tape drive 40 is removed from the tape storage device 4-2, and a new tape drive 40 is installed (replaced) in the tape drive device 4-2.

(7) After this replacement, the operator operates the operator panel of the tape storage device 4-2, and changes the new tape drive to online mode.

(8) The operator views the operator panel of the tape storage device 4-2, and confirms that the tape drive 40 is normal (abnormalities are cleared).

(9) The operators acquires WWN (new WWN) of the new tape drive on the operation terminal 62 via LAN port 60.

(10) The operator connects the storage processor of the standby system (e.g. 3-2) on the operation terminal 62 via the LAN port 60 by communication protocol so that internal access can be performed.

(11) The operator confirms that WWN (old WWN) of the tape drive 40 before replacement is set in the storage processor of the standby system 3-2 on the operation terminal 62.

(12) By this, WWN of the tape drive 40 before replacement in the storage processor of the standby system 3-2 is read and transmitted to the operation terminal 62, and is confirmed on the operation terminal 62.

(13) After this configuration, the setting of the WWN (old WWN) of the tape drive before replacement, in the storage processor of the standby system 3-2, is deleted, and WWN (new WWN) of the new tape drive 40 is set on the operation terminal 62.

(14) By this, setting of WWN of the tape drive 40 before replacement in the storage processor of the standby system 3-2 is deleted, and WWN (new WWN) of the new tape drive 40 is set.

(15) The operator confirms that WWN (new WWN) of the tape drive 40 after replacement is set in the storage processor of the standby system 3-2 on the operation terminal 62.

(16) By this, WWN of the tape drive 40 after replacement in the storage processor of the standby system 3-2 is read, is sent to the operation terminal 62, and is confirmed on the operation terminal 62.

(17) Then setup processing of the current system is performed. First the operator connects the storage processor of the current system (e.g. 3-1) on the operation terminal 62 via the LAN port 60 by communication protocol so that internal access can be performed.

(18) The operator confirms that WWN (old WWN) of the tape drive 40 before replacement is set in the storage processor of the current system 3-1 on the operation terminal 62.

(19) By this, WWN of the tape drive 40 before replacement in the storage processor of the current system 3-1 is read, is transmitted to the operation terminal 62, and is confirmed on the operation terminal 62.

(20) After this confirmation, the setting of the WWN (old WWN) of the tape drive 40 before replacement of the storage processor of the current system 3-1 is deleted, and WWN (new WWN) of the new tape drive 40 is set on the operation terminal 62.

(21) By this, the setting of WWN of the tape drive 40 before replacement in the storage processor of the current system 3-1 is deleted, and WWN (new WWN) of the new tape drive 40 is set.

(22) The operator confirms that WWN (new WWN) of the tape drive 40 after replacement is set in the storage processor of the current system 3-1 on the operation terminal 62.

(23) By this, WWN of the tape drive 40 after replacement in the storage processor of the current system 3-1 is read, is sent to the operation terminal 62, and is confirmed on the operation terminal 62.

(24) During active maintenance this current system 3-1 then becomes the standby system, and the standby system 3-2 becomes the current system, so after setup completes, the current system and the standby system of the storage processor are switched on the operation terminal 62.

(25) The disabled status of the tape drives 40 of the storage processors 3-1 and 3-2 is cleared on the operation terminal 62.

(26) It is confirmed on the operation terminal 62 that the tape drive 40 after maintenance (replacement) is normal.

(27) Log out from the storage processors 3-1 and 3-2 of the current system and the standby system is performed on the operation terminal 62 (internal access status is cleared).

In other words, for active maintenance, access to the storage processors 3-1 and 3-2 and the tape drive 40 is disabled, then the storage processors are connected to confirm and change the settings of WWN thereof, and to confirm the changes, and operation to clear disabled access to the storage processors 3-1 and 3-2 and the tape drive 40 is executed.

On the other hand, when the emulator device 5 is installed in the tape drive 40, as shown in FIG. 1, the emulator device 5 stores WWN of the tape drive 40 before replacement, and reads and stores WWN of the tape drive 40 after replacement. By this, emulation of WWN is executed. The emulator device 5 also detects replacement, and clears the connection and makes the reconnection of the storage processors 3-1 and 3-2 and the tape drive 40.

Therefore the conventional confirmation and the resetting operation of WWN the maintenance target tape drive 40 are unnecessary. Specifically in the case of the conventional operation (4) to acquire WWN of the maintenance target tape drive 40 on the operation terminal, it is unnecessary to acquire old WWN since the emulator device 5 loads and stores WWN of the tape drive 40.

In the same way, the conventional operation of (9)-(24) is also unnecessary, since the emulator device 5 loads and stores the old WWN of the original tape drive 40, and therefore the new WWN of the new tape drive 40 is transparent to the storage processor.

From the view of the storage processor, the emulator device 5 converts the new WWN into the original WWN. The emulator passes data other than WWN directly to the new tape drive 40. In other words, by connecting the emulator device 5 to the tape drive 40, the storage server 3 does not recognize the replacement of the tape drive 40. Therefore a complicated operation is unnecessary, and clearing disabled status on the operation terminal 62 is sufficient.

Therefore according to the present invention, the above mentioned maintenance replacement operation becomes as follows.

(A) Just like (1), the status of each unit is acquired from the LAN port 60 by the browser of the maintenance terminal (hereafter operation terminal) 62, and abnormalities of the tape drive 40 of the tape storage device 4-2 are confirmed.

(B) Just like (2), the operator visually confirms the abnormalities of the tape drive 40 on the operator panel (not illustrated) of the tape storage device 4-2.

(C) Just like (3), a command is issued from the operation terminal 62 to the storage server 3, and access from the storage server 3 to the tape drive 40 is disabled.

(D) (4) is omitted, and just like (5), the operator operates the operator panel of the tape storage device 4-2, and changes the tape drive 40 to offline mode.

(E) Just like (6), after disconnecting the maintenance target tape drive 40, the maintenance target tape drive 40 is removed from the tape storage device 4-2, and a new tape drive 40 is installed (replaced) in the tape drive device 4-2.

(F) Just like (7), after this replacement, the operator operates the operator panel of the tape storage device 4-2, and changes the new tape drive to online mode.

(G) Just like (8), the operator views the operator panel of the tape storage device 4-2, and confirms that the tape drive 40 is normal (abnormalities are cleared).

(H) (9)-(24) are omitted, and just like (25), the disabled status of the tape drive 40 of the storage processors 3-1 and 3-2 is cleared on the operation terminal 62.

(I) Just like (26), it is confirmed on the operation terminal 62 that the tape drive 40 after maintenance (replacement) is normal. Furthermore, (27) is unnecessary.

In this way, according to the present embodiment, operation on the operation terminal 62 and confirmation operation can be minimized and the number of operations can be decreased by installing the emulator device 5 between the maintenance target unit and the processor, and operation time can be decreased and operation errors can be prevented.

Emulator Device

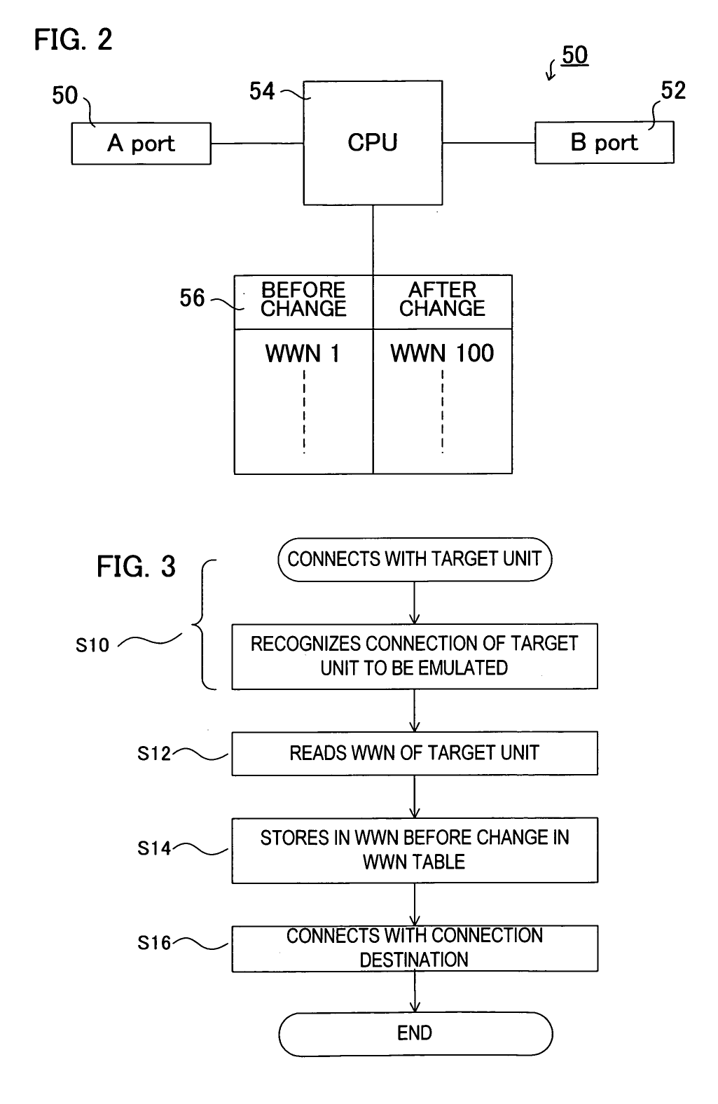

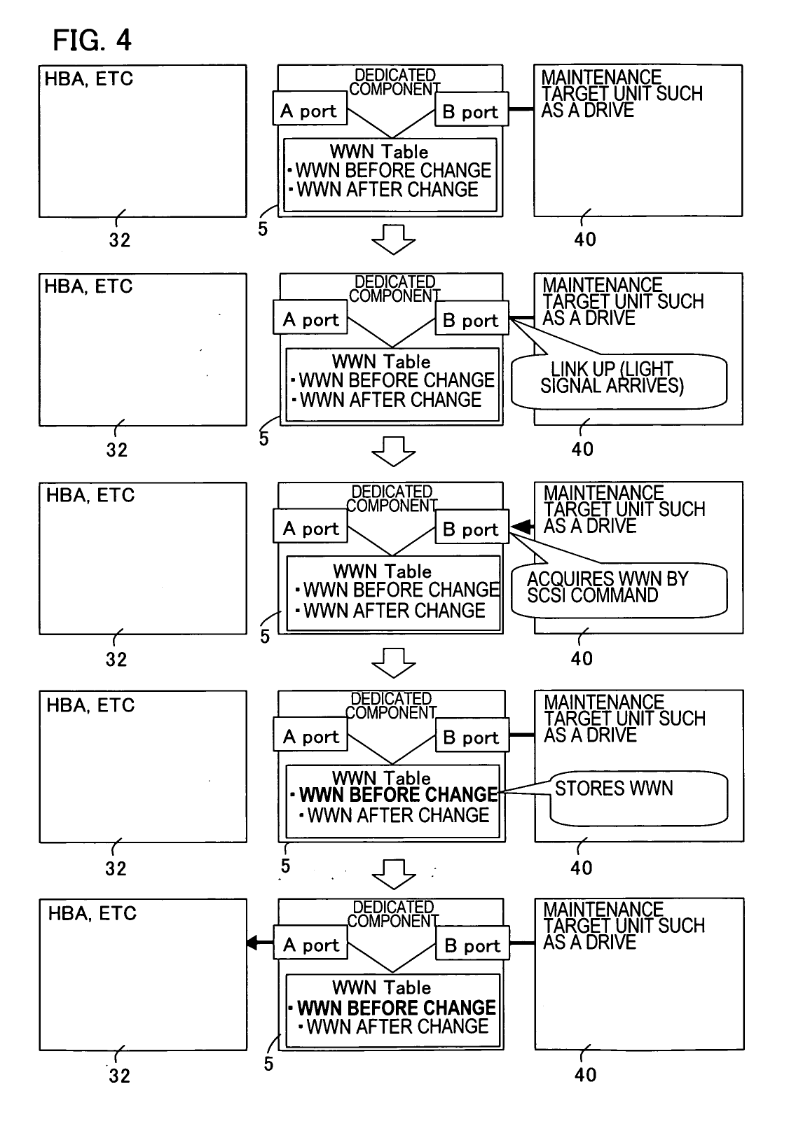

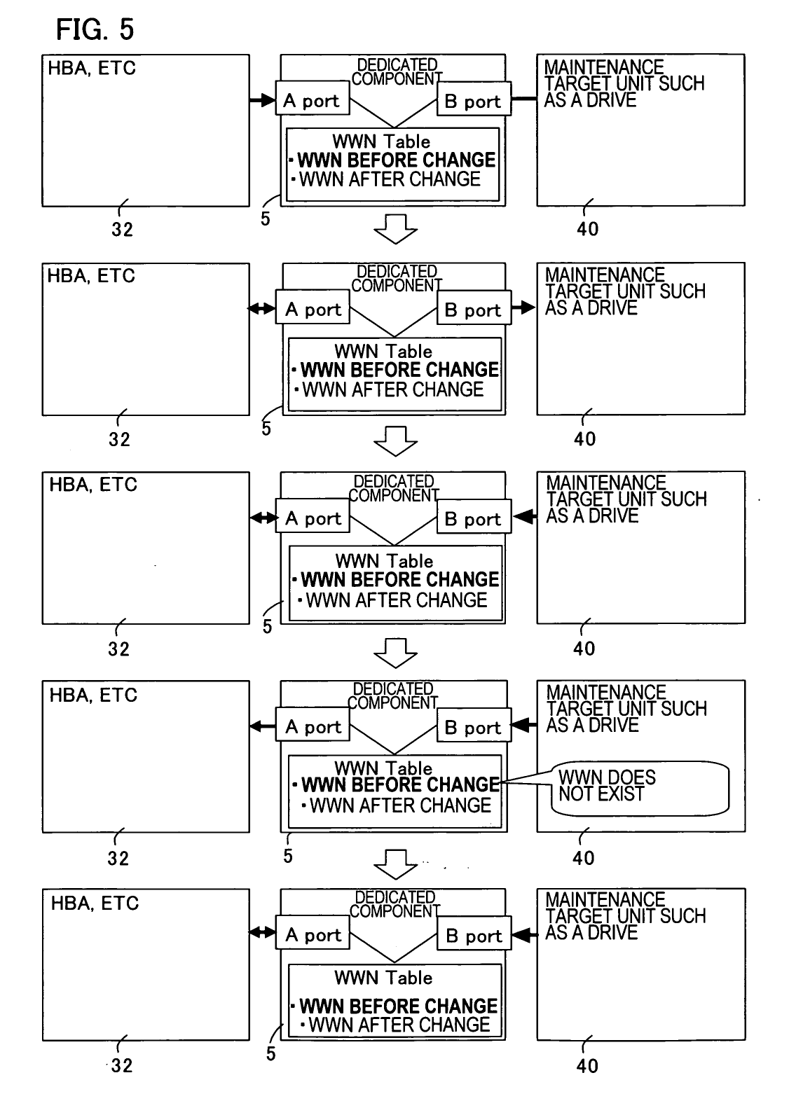

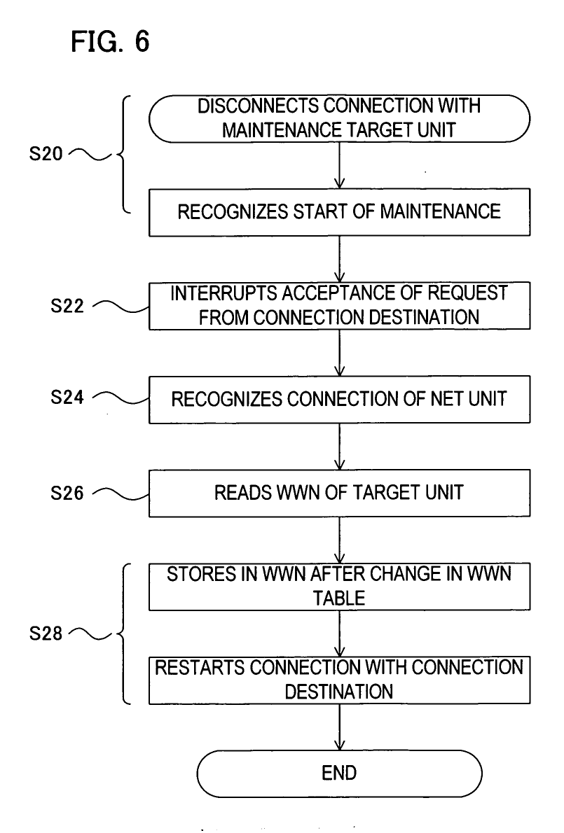

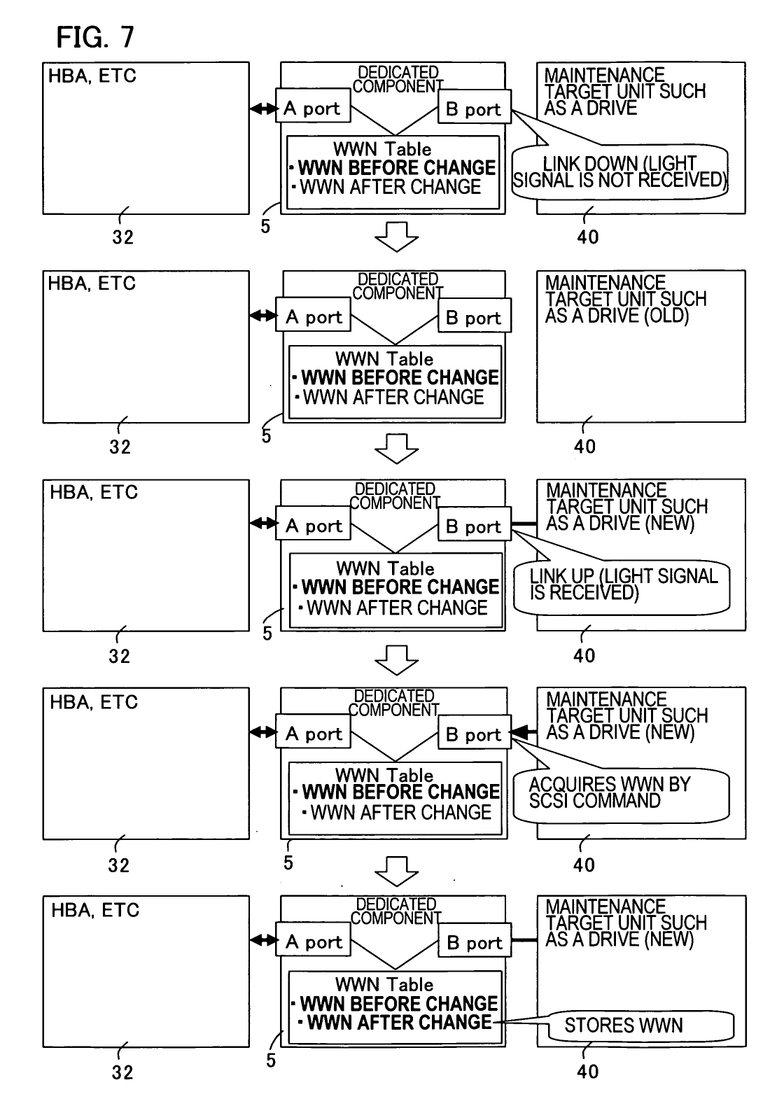

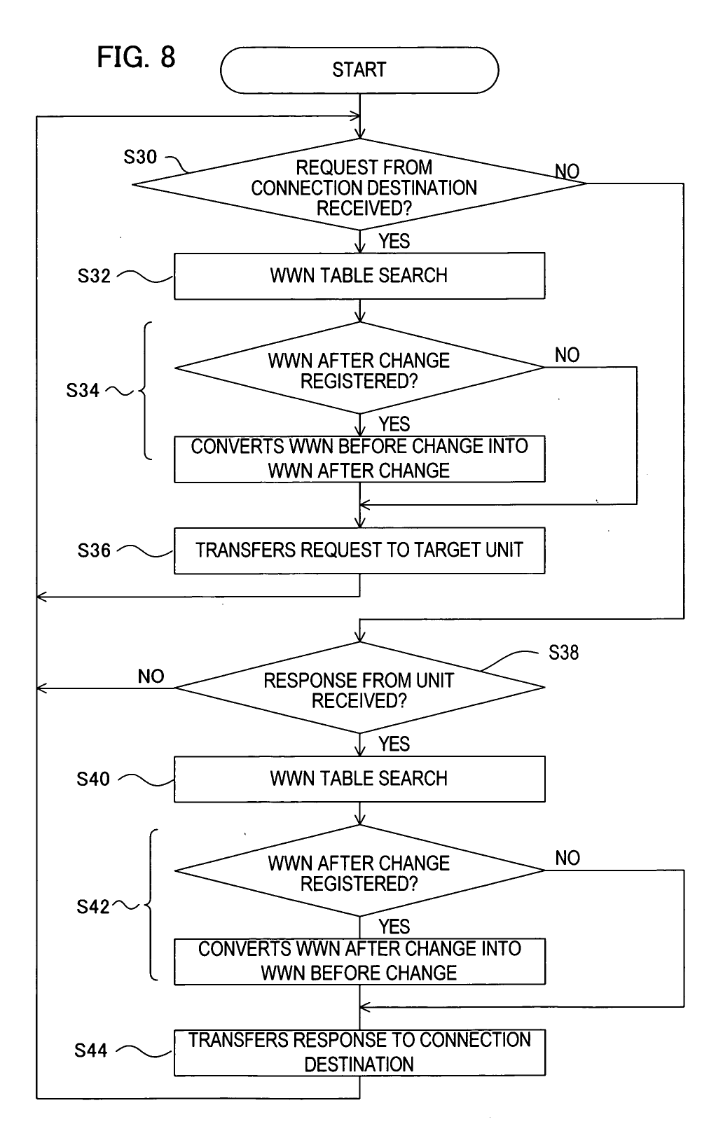

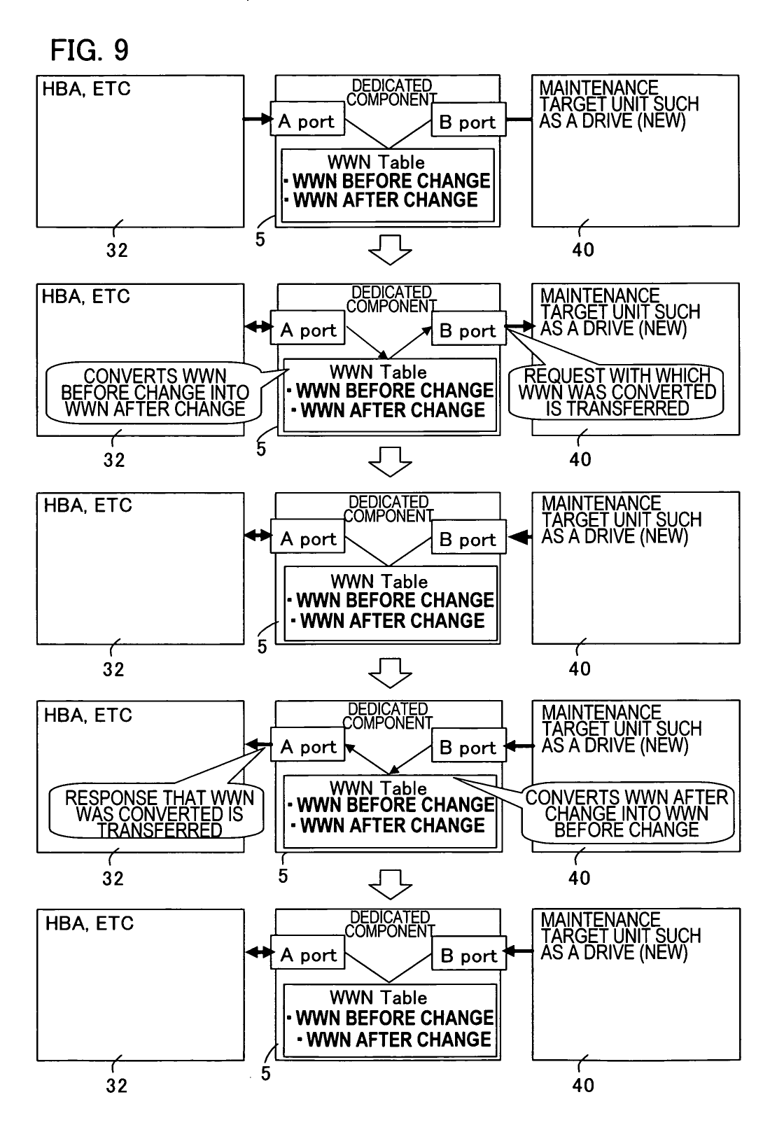

Now the above mentioned emulator device 5 will be described with reference to FIG. 2 to FIG. 9. FIG. 2 is a block diagram depicting the emulator device according to an embodiment of the present invention, FIG. 3 is a flow chart depicting the processing when the emulator device in FIG. 2 is installed, FIG. 4 is a diagram depicting the operation in FIG. 3, FIG. 5 is a diagram depicting operation before replacement, FIG. 6 is a flow chart depicting the processing when a component is replaced by the emulator device in FIG. 2, FIG. 7 is a diagram depicting the operation in FIG. 6, FIG. 8 is a flow chart depicting the processing after a device is replaced by the emulator device in FIG. 2, and FIG. 9 is a diagram depicting the operation in FIG. 8.

As FIG. 2 shows, the emulator device 5 has an A port 50 which is connected to the host adapter (HBA) 32 of the 'storage processors 3-1 and 3-2, a B port 52 which is connected to the tape drive (maintenance replacement target) 40, a processing unit (CPU) 54 for executing emulator processing, and a table 56 for storing the data corresponding old WWN before replacement and new WWN after replacement.

Now the processing when the device is installed, shown in FIG. 3, will be described with reference to FIG. 4.

(S10) First the B port 52 of the emulator device 5 is connected to the maintenance target tape drive 40. The processing unit 54 judges whether the B port 52 linked up (that is, whether a light signal was received from the tape drive 40), and confirms the connection of the maintenance target unit (tape drive) 40 to be emulated by this link up.

(S12) After link up is detected, the processing unit 54 reads WWN of the maintenance target unit 40 from the maintenance target unit 40 to be emulated by SCSI (Small Computer System Interface).

(S14) And the processing unit 54 stores WWN which was read to the WWN before replacement in the table 56.

(S16) Then the A port 50 of the emulator device 5 is connected to the host adapter 32, which is the connection destination of the maintenance target unit 40.

In this way, the emulator device 5 confirms the connection with the maintenance target unit 40 when connected to the maintenance target unit 40, reads WWN of the maintenance target unit 40, stores WWN before replacement in the table 56 so as to automatically connect with the connection destination.

Now operation of the emulator device 5 before replacing the maintenance replacement target unit 40 will be described with reference to FIG. 5. When the emulator device 5 receives a data write or data read request from the host adapter (HBA) 32 via the A port 50, the emulator device 5 transfers the request to the maintenance target unit 40 through the B port 52.

Then for this request, the maintenance target unit 40 executes the requested processing (e.g. read or write processing), and returns the response to the B port 52. In this response, WWN, which is the identifier of the maintenance target unit 40, is included. The processing unit 54 of the emulator device 5 confirms that WWN after replacement has not been registered corresponding to the WWN included in the response in the table 56. After the confirmation, the emulator device 5 transfers the response received via the B port 52 through the A port 50, so as to send the response to the host adapter (HBA) 32 via the A port 50. And the emulator device 5 receives the response receive confirmation from the host adapter (HBA) 32.

In this way, the emulator device 5 transfers the request from the host adapter 32 directly to the maintenance target unit 40, confirms that WWN after replacement has not been registered in the table 56, and transfers the response to the request from the maintenance target unit 40 directly to the host adapter 32.

Next, processing when the maintenance target unit 40 is replaced, shown in FIG. 6, will be described with reference to FIG. 7.

(S20) When the maintenance target tape drive 40 is removed, a light signal is no longer sent to the B port 52 of the emulator device 5. In other words, the maintenance target tape drive 40 and the B port 52 are linked down. The processing unit 54 judges whether the B port 52 is linked down (that is, whether a light signal is no longer received from the tape drive 40), and confirms that removal of the maintenance target unit (tape drive) 40 and the start of maintenance by this link down.

(S22) After link down is detected, the processing unit 54 disables the acceptance of the request from the connection destination (host adapter in this case) 32 through the A port 50.

(S24) And the operator performs maintenance, and connects the new tape drive 40 to the B port 52 of the emulator device 5. The B port 52 of the emulator device 5 once again receives a light signal. The processing unit 54 judges whether the B port 52 linked up (that is, whether a light signal was received from the tape drive 40), and confirms the connection of the new maintenance target unit (tape drive) 40 by this link up.

(S26) After link up is detected, the processing unit 54 reads WWN of the maintenance target unit 40 from the new maintenance target unit 40 by SCSI (Small Computer System Interface).

(S28) And the processing unit 54 stores WWN which was read to the WWN after replacement in the table 56 corresponding to WWN before replacement. Then the A port 50 of the emulator device 5 is connected to the host adapter 32, which is the connection destination of the maintenance target unit 40.

In this way, the emulator device 5 confirms the removal of the maintenance target unit 40 to be replaced, and disables the acceptance of requests, then confirms the connection of the new maintenance target unit 40, reads WWN of the new maintenance target unit 40, and stores it as the WWN after replacement in the table 56, so as to connect with the connection destination.

Now the processing of the emulator device 5 after the maintenance replacement target unit 40 is replaced, shown in FIG. 8, will be described with reference to FIG. 9.

(S30) First the processing unit 54 of the emulator device 5 judges whether a data write or data read request from the host adapter (HBA) 32 was received through the A port 50. If it is judged that the request was not received, the processing advances to step S38.

(S32) If it is judged that the request was received, on the other hand, the processing unit 54 searches the (WWN) table 56.

(S34) The processing unit 54 judges whether the request target WWN, included in the request from the A port 50, has been registered in WWN before replacement in the table 56. If the processing unit 54 judges that the request target WWN, included in the request from the A port 50, is not registered in WWN before replacement in the table 56, the processing advances to step S36. On the other hand, if the processing unit 54 judges that the request target WWN, included in the request from the A port 50, has been registered in WWN before replacement in the table 56, the processing unit 54 converts the request target WWN into the new WWN registered in the table 56.

(S36) The processing unit 54 issues the request including the request target WWN or the request including the converted WWN to the B port 52, and transfers it to the maintenance target unit 40. And the processing returns to step S30.

(S38) For this request, the maintenance target unit 40 executes the requested processing (e.g. read or write processing), and returns the response to the B port 52. In this response, WWN, that is the identifier of the maintenance target unit 40, is included. The processing unit 54 of the emulator device 5 first judges whether the response was received through the B port 52. If the response was not received, the processing unit 54 returns to step S30.

(S40) If it was judged that the response was received, the processing unit 54 searches the table 56.

(S42) The processing unit 54 judges whether the request target WWN, included in the response from the B port 52, has been registered in the WWN after replacement in the table 56. If the processing unit 54 judges that the request target WWN, included in the response from the B port 52, is not registered in WWN after replacement in the table 56, the processing advances to step S44. On the other hand, if the processing unit 54 judges that the request target WWN, included in the request from the B port 52, has been registered in WWN after replacement in the table 56, the processing unit 54 converts the new WWN from the request target into the old WWN registered in the table 56.

(S44) The processing unit 54 issues the response, including the request target WWN or the response including the converted WWN, to the A port 50, and sends the response from the A port 50 to the host adapter (HBA) 32. And the emulator device 5 receives the response reception confirmation from the host adapter (HBA) 32.

In this way, the emulator device 5 converts the request target WWN from the host adapter 32 into the new WWN of the replaced maintenance target unit 40, and transfers the new WWN, and if the WWN after replacement has been registered in the table 56, the emulator device 5 converts the response to the request from the maintenance target unit 40 into the old WWN, and transfers it to the host adapter 32.

By this emulation processing by the emulator device 5, connection with the replacement target is cleared and restarted, and WWN, which is an identifier, is converted even during active maintenance, so various settings, connections and connection clearing operations by the operator can be omitted, the operation time can be decreased, and operation errors can be prevented. Also the device specific WWN is emulated, so invalid access from the outside can be prevented, and security can be implemented.

### Second Embodiment of the Storage System

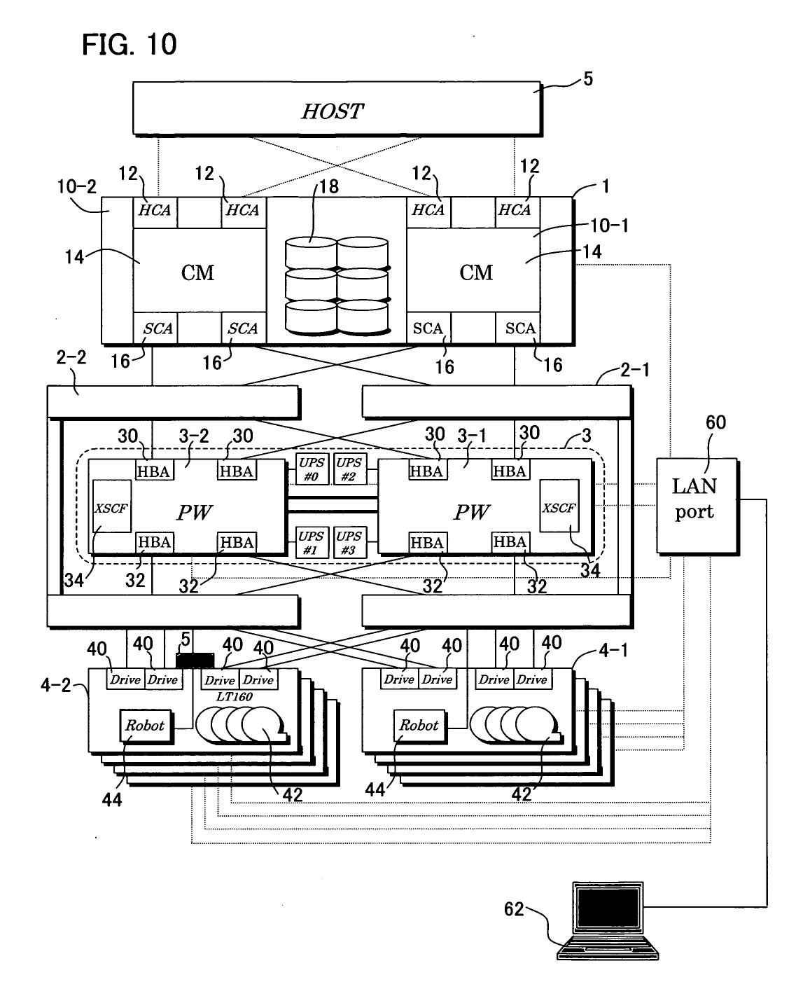

FIG. 10 is a block diagram depicting the second embodiment of the storage system of the present invention, and shows the maintenance replacement of the robot 44 of the virtual disk library device as an example.

In FIG. 10 composing elements the same as FIG. 1 are denoted with the same reference symbols. In FIG. 10 as well, the storage system has a disk storage device 1 which is connected to the host computer 6, fiber switches 2-1 and 2-2 for constructing the storage area network, tape storage devices 4-1 and 4-2, and a storage server (processor) 3 which is located between the disk storage device 1 and the tape storage device 4-1 and 4-2 for providing the function of the virtual disk to the tape storage devices 4-1 and 4-2.

In the case when the maintenance replacement target component is the robot 44, which is the tape transportation means of the tape storage device 4-2, the emulator device 5 is installed between the robot 44 and the fiber switch 2-2. And when maintenance replacement is performed, the maintenance terminal (e.g. personal computer) 62 is connected to the LAN port 60.

First a conventional maintenance replacement operation, where the above mentioned emulator device 5 is not installed, will be described for comparison.

(1) The status of each unit is acquired from the LAN port 60 by the browser of the maintenance terminal (hereafter operation terminal) 62, and abnormalities of the robot 44 of the tape storage device 4-2 are confirmed.

(2) The operator visually confirms the abnormalities of the robot 44 on the operator panel (not illustrated) of the tape storage device 4-2.

(3) By this confirmation, a command is issued on the operation terminal 62 to the storage server 3, and access from the storage server 3 to the robot 44 is disabled.

(4) WWN (World Wide Name, old WWN) of the maintenance target robot 44 is acquired on the operation terminal 62 via the LAN port 60.

(5) The operator operates the operator panel of the tape storage device 4-2, and changes the robot 44 to offline mode.

(6) After disconnecting the maintenance target robot 44 in this way, the maintenance target robot 44 is removed from the tape storage device 4-2, and a new robot 44 is installed (replaced) in the tape storage device 4-2.

(7) After this replacement, the operator operates the operator panel of the tape storage device 4-2, and changes the new robot 44 to online mode.

(8) The operator views the operator panel of the tape storage device 4-2, and confirms that the robot 44 is normal (abnormalities are cleared).

(9) The operator acquires WWN (new WWN) of the new robot 44 on the operator terminal 62 via the LAN port 60.

(10) The operator connects the storage processor of the standby system (e.g. 3-2) on the operation terminal 62 via the LAN port 60 by communication protocol so that internal access can be performed.

(11) The operator confirms that WWN (old WWN) of the robot 44 before replacement is set in the storage processor of the standby system 3-2 on the operation terminal 62.

(12) By this, WWN of the robot 44 before replacement in the storage processor of the standby system 3-2 is read and transmitted to the operation terminal 62, and is confirmed on the operation terminal 62.

(13) After this confirmation, the setting of WWN (old WWN) of the robot 44 before replacement of the storage processor of the standby system 3-2 is deleted, and WWN (new WWN) of the new robot 44 is set on the operation terminal 62.

(14) By this, setting of WWN of the robot 44 before replacement in the storage processor of the standby system 3-2 is deleted, and WWN (new WWN) of the new robot 44 is set.

(15) The operator confirms that WWN (new WWN) of the robot 44 after replacement is set in the storage processor of the standby system 3-2 on the operation terminal 62.

(16) By this, WWN of the robot 44 after replacement is in the storage processor of the standby system 3-2 is read, is sent to the operation terminal 62, and is confirmed on the operation terminal 62.

(17) Then setup processing of the current system is performed. First the operator connects the storage processor (e.g. 3-1) of the current system on the operation terminal 62 via the LAN port 60 by communication protocol so that internal access can be performed.

(18) The operator confirms that WWN (old WWN) of the robot 44 before replacement is set in the storage processor of the current system 3-1 on the operation terminal 62.

(19) By this, WWN of the robot 44 before replacement in the storage processor of the current system 3-1 is read and sent to the operation terminal 62, and is confirmed on the operation terminal 62.

(20) After this confirmation, the setting of WWN (old WWN) of the robot 44 before replacement of the storage processor of the current system 3-1 is deleted, and WWN (new WWN) of the new robot 44 is set on the operation terminal 62.

(21) By this, the setting of WWN of the robot 44 before replacement in the storage processor of the current system 3-1 is deleted, and WWN (new WWN) of the new robot 44 is set.

(22) The operator confirms that WWN (new WWN) of the robot 44 after replacement is set in the storage processor of the current system 3-1 on the operation terminal 62.

(23) By this, WWN of the robot 44 after replacement in the storage processor of the current system 3-1 is read, and is sent to the operation terminal 62, and is confirmed on the operation terminal 62.

(24) During active maintenance, this current system 3-1 becomes the standby system and the standby system 3-2 becomes the current system, and after setup is over the current system and the standby system of the storage processor are switched on the operation terminal 62.

(25) The disabled status of the robot 44 of the storage processors 3-1 and 3-2 is cleared on the operation terminal 62.

(26) It is confirmed that the robot 44 after maintenance (replacement) is normal on the operation terminal 62.

(27) Log out from the storage processors 3-1 and 3-2 of the current system and standby system is performed on the operation terminal 62 (internal access status is cleared).

In other words, for active maintenance, access to the storage processors 3-1 and 3-2 and the robot 44 is disabled, then the storage processor is connected to confirm and change the settings of WWN thereof, and to confirm these changes, and operation to clear disabled access to the storage processors 3-1 and 3-2 and the robot 44 is executed.

On the other hand, when the emulator device 5 is installed in the robot 44, as shown in FIG. 10, the emulator device 5 stores WWN of the robot 44 before replacement, and reads and stores WWN of the robot 44 after replacement. By this, emulation of WWN is executed. The emulator device 5 also detects replacement, and clears the connection, and makes a reconnection of the storage processors 3-1 and 3-2 and the robot 44.

Therefore conventional confirmation and resetting operation of the maintenance target robot 44 are unnecessary. Specifically in the case of the conventional operation (4) to acquire WWN of the maintenance target robot 44 on the operation terminal, it is unnecessary to acquire the old WWN since the emulator device 5 loads and stores WWN of the robot 44.

In the same way, the conventional operation of (9)-(24) is also unnecessary since the emulator device 5 loads and stores the old WWN of the original robot 44, and therefore the new WWN of the new robot 44 is transparent to the storage processor 3.

From the view of the storage processor 3, the emulator device 5 converts the new WWN into the original WWN. The emulator passes the data other than WWN directly to the new robot 44. In other words, by connecting the emulator device 5 to the robot 44, the storage server 3 does not recognize the replacement of the robot 44. Therefore a complicated operation is unnecessary, and clearing disabled status on the operation terminal 62 is sufficient.

Therefore according to the present invention, the above mentioned maintenance replacement operation becomes as follows.

(A) Just like (1), the status of each unit is acquired from the LAN port 60 by the browser of the maintenance terminal (hereafter operation terminal) 62, and the abnormalities of the robot 44 of the tape storage device 4-2 are confirmed.

(B) Just like (2), the operator visually confirms the abnormalities of the robot 44 on the operator panel (not illustrated) of the tape storage device 4-2.

(C) Just like (3), a command is issued from the operation terminal 62 to the storage server 3, and access from the storage server 3 to the robot 44 is disabled.

(D) (4) is omitted, and just like (5), the operator operates the operator panel of the tape storage device 4-2, and changes the robot 44 to offline mode.

(E) Just like (6), after disconnecting the maintenance target robot 44, the maintenance target robot 44 is removed from the tape storage device 4-2, and a new robot 44 is installed (replaced) in the tape drive device 4-2.

(F) Just like (7), after this replacement, the operator operates the operator panel of the tape storage device 4-2, and changes the new robot 44 to online mode.

(G) Just like (8), the operator views the operator panel of the tape storage device 4-2, and confirms that the robot 44 is normal (abnormalities are cleared).

(H) (9)-(24) are omitted, and just like (25), the disabled status of the robot 44 of the storage processors 3-1 and 3-2 is cleared on the operator terminal 62.

(I) Just like (26), it is confirmed on the operation terminal 62 that the robot 44 after maintenance (replacement) is normal. Furthermore, (27) is unnecessary.

In this way, according to the present embodiment, the operation on the operation terminal 62 and the confirmation operation can be minimized, and the number of operations can be decreased by installing the emulator device 5 between the maintenance target unit and the processor, and therefore operation time can be decreased and operation errors can be prevented.

### Third Embodiment of the Storage System

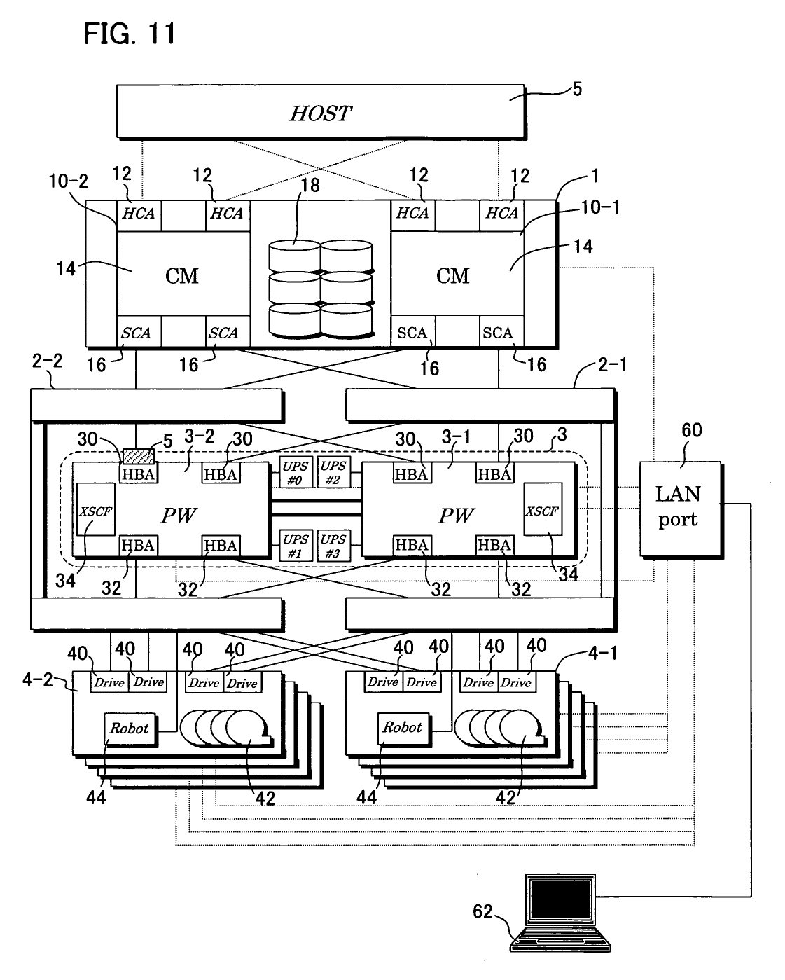

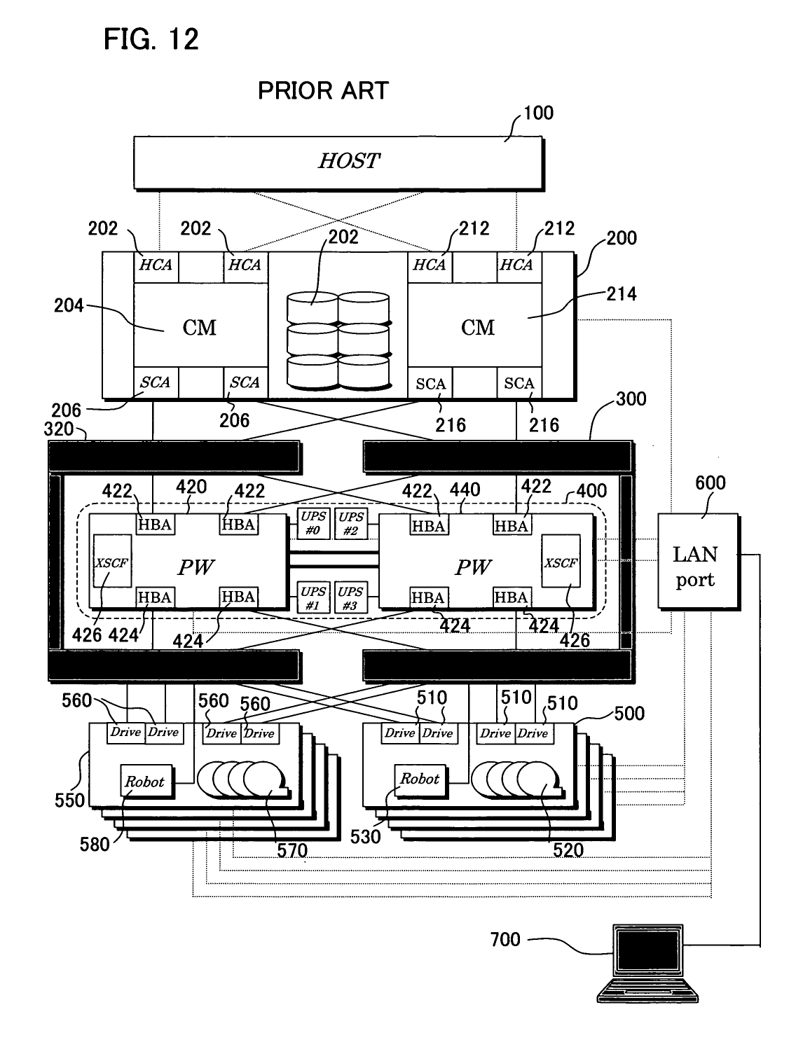

FIG. 11 is a block diagram depicting the third embodiment of the storage system of the present invention, and shows the maintenance replacement of the host adapter 30 of the storage processor 3 of the virtual disk library device as an example.

In FIG. 11, composing elements the same as FIG. 1 and FIG. 10 are denoted with the same reference symbols. In FIG. 11 as well the storage system has a disk storage device 1, which is connected to the host computer 6, fiber switches 2-1 and 2-2 for constructing the storage area network, tape storage device 4-1 and 4-2, and a storage server (processor) 3 which is located between the disk storage device 1 and the tape storage devices 4-1 and 4-2 for providing the function of the virtual disk to the tape storage devices 4-1 and 4-2.

In the case when the maintenance replacement target component is the host adaptor 30 of the storage processor 3-2, the emulator device 5 is installed between the host adapter 30 and the fiber switch 2-2. And when maintenance replacement is performed, the maintenance terminal (e.g. personal computer) 62 is connected to the LAN port 60.

First a conventional maintenance replacement operation, where the above mentioned emulator device 5 is not installed, will be described for comparison.

(1) The status of each unit is acquired from the LAN port 60 by the browser of the maintenance terminal (hereafter operation terminal) 62, and the abnormalities of the host adapter 30 of the storage processor 3-2 of one system are confirmed.

(2) If the replacement target host adapter 30 is of the current system 3-1 of the storage processor, the operator switches the current system 3-1 to the standby system on the operation terminal 62.

(3) The operator confirms that the storage processor, having the replacement target host adaptor 30, has been switched to the standby system on the operation terminal 62.

(4) By this confirmation, a command is issued from the operation terminal 62 to the storage processor of the standby system 3-2, and operation to stop the execution of the application of the storage processor 3-2 is performed.

(5) The operator connects the storage processor of the standby system (e.g. 3-2) on the operation terminal 62 via the LAN port 60 by communication protocol, and disables automatic startup of the application.

(6) The path between the storage processor of the current system 3-1 and the disk storage device 1 and the path between the storage processor of the standby system 3-2 and the disk storage device 1 are confirmed on the operation terminal 62 via the LAN port 60.

(7) The operator confirms that the path between the storage processor of the current system 3-1 and the disk storage device 1 is normal on the screen of the operation terminal 62.

(8) The path between the storage processor of the current system 3-1 and the tape storage device 4-1/4-2 is confirmed on the operation terminal 62 via the LAN port 60.

(9) The operator confirms that the path between the storage processor of the current system 3-1 and the tape storage device 4-1/4-2 is normal on the screen of the operation terminal 62.

(10) After confirming the connection of the current system and disconnecting the maintenance target host adapter 30 in this way, the maintenance target host adapter 30 is removed from the storage processor of the standby system 3-2, and a new host adapter 30 is installed (replaced) in the storage processor 3-2.

(11) After this replacement, the operator operates the operation terminal 62, and turns the power of the storage processor of the standby system 3-2 ON/OFF.

(12) The operator acquires WWN (new WWN) of the new host adapter 30 on the operation terminal 62 via the LAN port 60.

(13) The operator connects the storage processor of the standby system (e.g. 3-2) on the operation terminal 62 via the LAN port 60 by communication protocol, so that the disabled automatic startup of the application is cleared.

(14) The operator sets the path from the operation terminal 62 to the control unit (e.g. 14 of 10-1) which is set by the disk storage device 1 to offline mode.

(15) After this, the setting of WWN (old WWN) of the host adapter before replacement in the host table 14 of the control unit 10-1 of the disk storage device 1 is deleted, and WWN (new WWN) of the new host adapter 30 is set on the operation terminal 62, so that the replaced host adapter 30 can be accessed by the disk storage device 1.

(16) The operator sets the ports of the server channel adapter of the control unit (e.g. 14 of 10-1), which was set to offline mode, of the disk storage device 1 on the operation terminal 62.

(17) The operator returns the path from the storage processor of the current system 3-1 to the control unit (14 of 10-1) which is set in the disk storage device 1 to online mode on the operation terminal 62.

(18) This procedure (14)-(17) is repeated for the number of control units of the disk storage device 1.

(19) The operator confirms the path between the storage processor of the standby system 3-2 and the disk storage device 3 on the operation terminal 62, and confirms that the path between the storage processor of the standby system 3-2 and the disk storage device 3, which was in offline mode, is now in online mode.

(20) By this confirmation, a command is issued from the operation terminal 62 to the storage processor of the standby system 3-2, and operation to restart execution of the application of the storage processor 3-2 is performed.

(21) The operator confirms that the replaced host adapter 30 is integrated into the application of the storage processor of the standby system (e.g. 3-2) via the LAN port 60 on the operation terminal 62.

(22) On the operation terminal 62, the path between the storage processor of the current system 3-1 and the disk storage device 1, and the path between the storage processor of the standby system 3-2 and the disk storage device 1, are confirmed via the LAN port 60.

(23) The operator confirms that the path between the storage processor 3-1/3-2 and the disk storage device 1 is normal on the screen of the operation terminal 62.

(24) On the operation terminal 62, the path between the storage processor of the current system 3-1 and the tape storage device 4-1/4-2 is confirmed via the LAN port 60.

(25) The operator confirms that the path between the storage processor of the current system 3-1 and the tape storage device 4-1/4-2 is normal on the screen of the operation terminal 62.

In other words, for active maintenance, execution of the application of the storage processor 3-1 or 3-2 having the replacement target host adapter 30 is disabled, then the path is confirmed, the host adapter is replaced, the WWN thereof is acquired, the path to the disk storage device 1 is set to offline mode, a new WWN is set for the disk storage device 1, the path to the disk storage device is set to online mode, and path connection confirmation is executed.

On the other hand, when the emulator device 5 is installed in the host adapter 30, as shown in FIG. 11, the emulator device 5 acquires WWN of the old host adapter and acquires WWN of the new host adapter 30. Therefore the conventional operation to acquire WWN of the maintenance target host adapter 30 and the operation to set the disk storage device 1 are unnecessary.

Specifically the conventional operation (12) to acquire the new WWN of the maintenance target host adapter 30 on the operation terminal is unnecessary, since the emulator device 5 loads and stores the new WWN of the host adapter 30.

In the same way, the conventional operation of (13)-(18) is also unnecessary, since the emulator device 5 loads and stores the new WWN of the new host adapter 30, and therefore the new WWN of the new host adapter 30 is transparent to the disk storage device 1.

The emulator device 5 can convert the new WWN into the original WWN until access from the disk storage device 1. The emulator device 5 passes the data other than WWN directly to the storage processor. The replacement of the host adapter 30 is transparent to the disk storage device 1. Therefore a complicated operation is unnecessary, and clearing the disabled status on the operation terminal is sufficient.

Therefore according to the present invention, the above mentioned maintenance replacement operation becomes as follows.

(A) Just like (1), the status of each unit is acquired from the LAN port 60 by the browser of the maintenance terminal (hereafter operation terminal) 62, and the abnormalities of the host adapter 30 of the storage processor 3-2 of one system are confirmed.

(B) Just like (2), if the replacement target host adapter 30 is that of the current system 3-1 of the storage processor, the operator switches the current system 3-1 to the standby system on the operation terminal 62.

(C) Just like (3), the operator confirms that the storage processor having the replacement target host adapter 30 has been switched to the standby system on the operation terminal 62.

(D) Just like (4), by this confirmation, a command is issued from the operation terminal 62 to the storage processor of the standby system 3-2, and the operation to stop the execution of the application of the storage processor 3-2 is performed.

(E) (5) is omitted, and just like (6), the path between the storage processor of the current system 3-1 and the disk storage device 1, and the path between the storage processor of the standby system 3-2 and the disk storage device 1, are confirmed on the operation terminal 62 via the LAN port 60.

(F) Just like (7), the operator confirms that the path between the storage processor of the current system 3-1 and the disk storage device 1 is normal on the screen of the operation terminal 62.

(G) Just like (8), the path between the storage processor of the current system 3-1 and the tape storage device 4-1/4-2 is confirmed on the operation terminal 62 via the LAN port 60.

(H) Just like (9), the operator confirms that the path between the storage processor of the current system 3-1 and the tape storage device 4-1/4-2 is normal on the screen of the operation terminal 62.

(I) Just like (10), after confirming the connection of the current system and disconnecting the maintenance target host adapter 30, the maintenance target host adapter 30 is removed from the storage processor of the standby system 3-2, and a new host adapter 30 is installed (replaced) in the storage processor 3-2.

(J) (11)-(18) are omitted, and just like (19), the operator confirms the path between the storage processor of the standby system 3-2 and the disk storage device 3 on the operation terminal 62, and confirms that the path between the storage processor 3-2 of the standby system and the disk storage device 3, which was in offline mode, is now in online mode.

(K) Just like (20), by this confirmation, a command is issued from the operation terminal 62 to the storage processor of the standby system 3-2, and the operation to restart execution of the application of the storage processor 3-2 is performed.

(L) Just like (21), the operator confirms that the replaced host adapter 30 is integrated into the application of the storage processor of the standby system (e.g. 3-2) via the LAN port 60 on the operation terminal 62.

(M) Just like (22), the path between the storage processor of the current system 3-1 and the disk storage device 1, and the path between the storage processor of the standby system 3-2 and the disk storage device 1, are confirmed on the operation terminal 62 via the LAN port 60.

(N) Just like (23), the operator confirms that the path between the storage processor 3-1/3-2 and the disk storage device 1 is normal on the screen of the operation terminal 62.

(O) Just like (24), the path between the storage processor of the current system 3-1 and the tape storage device 4-1/4-2 is confirmed on the operation terminal 62 via the LAN port 60.

(P) Just like (25), the operator confirms that the path between the storage processor of the current system 3-1 and the tape storage device 4-1/4-2 is normal on the screen of the operation terminal 62.

In this way, according to the present embodiment, the emulator device 5 is installed between the maintenance target unit and the disk storage device, so the operation on the operation terminal 62 and the confirmation operation can be minimized, the number of operations can be decreased,. and therefore the operation time can be decreased and operation errors can be prevented.

### Other Embodiments

In the above mentioned embodiments, the device specific identifier is WWN, but another identifier may be used. The primary storage device was described as a disk storage device and the secondary storage device was described as a tape storage device, but the primary storage device may be a semiconductor memory storage device or another storage device, and in the same way, the secondary storage device may be a disk storage device or another storage device. In other words, a system requires a different type of primary storage device and secondary storage device, and a processor for relay, to perform virtual storage processing of the primary storage device, is installed there between.

Also in the above embodiments the storage processor is duplicated, but the present invention can also be applied to a single storage processor without redundancy. Also the disk storage device was described as a magnetic disk storage device, but the present invention can also be applied to a storage device using another storage medium, such as an optical disk and a magneto-optical disk.

Since the emulator device for emulating the identifier of the maintenance target unit is installed between the installation port of the maintenance target unit of the storage system in a hierarchical configuration and the maintenance target unit, the storage system cannot recognize this change if the maintenance target unit is replaced. By this, the complicated setting operation when the maintenance target unit is replaced can be eliminated, and operation errors can be prevented. Also the emulator device is installed in the maintenance target unit, so a security mechanism, to which access from the outside is prohibited, can be constructed.

What is claimed is:

1. A storage system, comprising:
a primary storage device comprising a data storage section, for receiving an access request from a host, reading/writing data in said storage section, and returning the data to the host;
a secondary storage device comprising a data storage section, for reading/writing data in the data storage section according to a read/write request from said primary storage device;
a storage processor installed between said primary storage device and said secondary storage device, for having said secondary storage device virtually execute read/write operation of said primary storage device when a request from said primary storage device is received, and
an emulator device connected to at least one of the maintenance target units of said secondary storage device and said storage processor, for converting an identifier before replacement and an identifier after replacement of said maintenance target unit,
wherein said emulator device converts the identifier of said maintenance target unit when exchanging information between said primary storage device and said secondary storage device.

2. The storage system according to claim 1, wherein said emulator device detects the connection of one of the maintenance target units of said secondary storage device and said storage processor, acquires and stores an identifier of said maintenance target unit, detects the replacement of said maintenance target unit, acquires an identifier of said maintenance target unit after the replacement, and stores the identifier after the replacement corresponding to said identifier before the replacement.

3. The storage system according to claim 1, wherein said emulator device comprises:
a first port for connection to said primary storage device or said storage processor;
a second port for connection to said maintenance target unit;
a table for storing an identifier after the replacement corresponding to the identifier before the replacement; and
a processing unit for referring to said table and converting an identifier of said maintenance target unit when exchanging information between said primary storage device and said secondary storage.

4. The storage system according to claim 3, wherein said emulator device detects that one of the maintenance target units of said secondary storage device and said storage processor is removed, disables acceptance of a signal from said primary storage device or said storage processor which accesses said maintenance target unit from said first port, detects that said maintenance target unit is replaced, and enables acceptance of the signal from said primary storage device or said storage processor.

5. The storage system according to claim 2, wherein said emulator device detects that one of the maintenance target units of said secondary storage device and said storage processor is connected, acquires and stores WWN of said maintenance target unit, detects that said maintenance target unit is replaced, acquires WWN of said maintenance target unit after the replacement, and stores WWN after the replacement corresponding to the WWN before the replacement.

6. The storage system according to claim 1, further comprising an operation terminal connected to said primary storage device, said secondary storage device, and said storage processor, for disabling access to said maintenance target unit before replacing said maintenance target unit, and enabling access to said maintenance target unit after replacing said maintenance target unit.

7. The storage system according to claim 1, wherein said secondary storage device comprises:
a tape drive for driving a storage tape; and
a robot for transporting said storage tape between said tape drive and a tape storage section,
and wherein said emulator device is installed in one of said tape drive and said robot, which exchanges information with said storage processor.

8. The storage system according to claim 1, wherein said storage processor has an interface circuit for interfacing with said primary storage device,
and wherein said emulator device is installed in said interface circuit, which exchanges information with said primary storage device.

9. The storage system according to claim 1, wherein said primary storage device is a disk storage device,
and wherein said storage processor controls said secondary storage device as a virtual disk.

10. The storage system according to claim 9, wherein said secondary storage device comprises:
a tape drive for driving a storage tape; and
a robot for transporting said storage tape between said tape drive and a tape storage section.

11. A component replacement processing method for a storage system which comprises a primary storage device for receiving an access request from a host, reading/writing data in storage section of said primary storage device, and returning the data to the host, a secondary storage device for reading/writing data in data storage section of said secondary storage device according to a read/write request from said primary storage device, and a storage processor installed between said primary storage device and said secondary storage device, for having said secondary storage device virtually execute read/write operation of said primary storage device when a request from said primary storage device is received, the method comprising steps of:
connecting an emulator device to at least one of the maintenance target units of said secondary storage device and said storage processor;
acquiring an identifier of the maintenance target component; and
converting an identifier of said maintenance target unit by said emulator device when exchanging information between said primary storage device and said secondary storage device via said storage processor after replacing the maintenance target component.

12. The component replacement processing method for a storage system according to claim 11, wherein said acquisition step comprises:
a step of detecting that said emulator device is connected to one of the maintenance target units of said secondary storage device and said storage processor;
a step of acquiring and storing an identifier of said maintenance target unit;
a step of detecting that said maintenance target unit is replaced; and
a step of acquiring an identifier of said maintenance target unit after the replacement, and storing the identifier after the replacement corresponding to said identifier before the replacement.

13. The component replacement processing method for a storage system according to claim 11, wherein said conversion step comprises a step executed by said emulator device which comprises:
a first port for connection to said primary storage device or said storage processor;
a second port for connection to said maintenance target unit;
a table for storing an identifier after the replacement corresponding to the identifier before the replacement; and
a processing unit for converting an identifier of said maintenance target unit by referring to said table when exchanging information between said primary storage device and said secondary storage device.

14. The component replacement processing method for a storage system according to claim 13, further comprising:
a step of detecting that one of the maintenance target units of said secondary storage device and said storage processor is removed;
a step of disabling acceptance of a signal from said primary storage device or said storage processor which accesses said maintenance target unit from said first port, by means of said emulator device;
a step of detecting that said maintenance target unit is replaced; and
a step of enabling acceptance of the signal from said primary storage device or said storage processor, by means of said emulator device.

15. The component replacement processing method for a storage system according to claim 12, wherein said acquisition step further comprises:
a step of detecting that said emulator device is connected to one of the maintenance target units of said secondary storage device and said storage processor;
a step of acquiring and storing WWN of said maintenance target unit, by means of said emulator device;
a step of detecting that said maintenance target unit is replaced; and
a step of acquiring WWN of said maintenance target unit after the replacement, and storing WWN after the replacement corresponding to the WWN before the replacement, by means of said emulator device.

16. The component replacement processing method for a storage system according to claim 11, further comprising:
a step of connecting an operation terminal to said primary storage device, said secondary storage device and said storage processor;
a step of disabling access to said maintenance target unit before replacement of said maintenance target unit by said operation terminal; and
a step of enabling access to said maintenance target unit after replacing said maintenance target unit.

17. The component replacement processing method for a storage system according to claim 11, wherein said acquisition step comprises a step executed by said emulator device installed in one of a tape drive and a robot of said secondary storage device which exchanges information with said storage processor.

18. The component replacement processing method for a storage system according to claim 11, wherein said acquisition step further comprises a step executed by said emulator device installed in an interface circuit of said storage processor which exchanges information with said primary storage device.

19. The component replacement processing method for a storage system according to claim 11, further comprising a step of controlling said secondary storage device as a virtual disk by means of said storage processor.

20. The component replacement processing method for a storage system according to claim 19, wherein said control step comprises a step for controlling, as a virtual disk, the secondary storage device which comprises a tape drive for driving a storage tape, and a robot for transporting said storage tape between said tape drive and a tape storage section.
